(19) United States
(12) Patent Application Publication
(10) Pub. No.: US 2015/0324809 A1
(43) Pub. Date: Nov. 12, 2015

(54) METHOD AND SYSTEM FOR DETERMINING POLITICAL AFFILIATIONS AND ATTITUDES

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil Malgatti, Stamford, CT (US)

(73) Assignee: MASTERCARD INTERNATIONAL INCORPORATED, Purchase, NY (US)

(21) Appl. No.: 14/270,647

(22) Filed: May 6, 2014

(51) Int. Cl. G06Q 30/02; G06Q 40/00

(52) U.S. Cl. CPC G06Q 30/0201; G06Q 40/12

(57) ABSTRACT

A method and a system are provided for determining political affiliations and/or attitudes of payment card holders. The method involves retrieving from one or more databases a first set of information including payment card transaction information, and retrieving from one or more databases a second set of information comprising external information. The external information includes merchant political affiliation and/or attitude information and payment card holder political affiliation and/or attitude information. The method further includes analyzing the first set of information and the second set of information to identify one or more associations between the payment card transaction information and the external information, and determining political affiliation and/or attitude of one or more payment card holders based on the one or more associations. The method and system can be used by merchants or businesses to better target customers or enhance existing customer relationships.

### BACKGROUND OF THE DISCLOSURE

1. Field of the Disclosure

The present disclosure relates to a method and a system for determining political affiliations and/or attitudes of payment card holders. The method and system can be used by merchants or businesses to better target customers or enhance existing customer relationships. The method and system can also be used for research purposes.

2. Description of the Related Art

Manufacturers, retailers, or other sellers of products (e.g. goods and services) spend a great deal of time and money trying to devise ways to get a consumer to buy their products. For example, companies advertise, send incentives for discounts, offer rewards, and other incentives to get consumers to initiate a transaction for the products. However, these efforts are typically provided to the public at large, or at least a relatively large group of consumers, which can result in a high cost and a low return. Also, the timing of any effort is typically based on when the seller wants to send an incentive, with the seller, perhaps, having no insight as to a beneficial time or manner to send an incentive.

The availability of payment card transaction data provides unique opportunities to service a customer using a payment card. A possible benefit is that if characteristics and/or activities of a payment card user are known, targeted advertising can be sent to the user of the payment card. Thus, the user is informed of targeted products (goods or services) that are available, and the issuer receives the possible benefit of one or more additional transactions being conducted by the payment card user.

Thus, a need exists for a system and a method that can identify, with as much certainty as possible, purchasing preferences of payment card users that may represent an opportunity for a merchant to offer products or services to the consumer that are specifically tailored to the consumer's upcoming need or desire and communicate the offers to the consumer.

### SUMMARY OF THE DISCLOSURE

The present disclosure provides a method and a system for determining political affiliations and/or attitudes of payment card holders. In particular, the present disclosure relates to a method and a system for determining political affiliations and/or attitudes of payment card holders based on payment card transaction information and external information. The external information comprises merchant political affiliation and/or attitude information and payment card holder political affiliation and/or attitude information. The method and system can be used by merchants or businesses to better target customers or enhance existing customer relationships. The method and system can also be used for research purposes.

The present disclosure also provides a method that involves retrieving from one or more databases a first set of information comprising payment card transaction information, and retrieving from one or more databases a second set of information comprising external information. The external information comprises merchant political affiliation and/or attitude information and payment card holder political affiliation and/or attitude information. The method further involves analyzing the first set of information and the second set of information to identify one or more associations between the payment card transaction information and the external information, and determining political affiliation and/or attitude of one or more payment card holders based on the one or more associations.

The present disclosure further provides developing logic for predicting political affiliations and/or attitudes. The present disclosure yet further provides applying the logic to a universe of payment card transaction information and external information to determine political affiliations and/or attitudes of one or more payment card holders.

The present disclosure also provides a system that includes one or more databases including a first set of information comprising payment card transaction information, and one or more databases including a second set of information comprising external information. The external information comprises merchant political affiliation and/or attitude information and payment card holder political affiliation and/or attitude information. The system further includes a processor configured to: analyze the first set of information and the second set of information to identify one or more associations between the payment card transaction information and the external information; and determine political affiliation and/or attitude of one or more payment card holders based on the one or more associations.

The present disclosure further provides a system in which the processor is configured with a programmed logic to predict political affiliations and/or attitudes. The present disclosure yet further provides a system in which the processor is configured to apply the logic to a universe of payment card transaction information and external information to determine political affiliations and/or attitudes of one or more payment card holders.

The present disclosure still further provides a method for generating one or more predictive political affiliation and/or attitude profiles. The method comprises retrieving from one or more databases a first set of information comprising payment card transaction information, and retrieving from one or more databases a second set of information comprising external information. The external information comprises merchant political affiliation and/or attitude information and payment card holder political affiliation and/or attitude information. The method further comprises analyzing the first set of information and the second set of information to identify one or more associations between the payment card transaction information and the external information, and generating one or more predictive political affiliation and/or attitude profiles based on the one or more associations. The method yet further comprises determining political affiliation and/or attitude of one or more payment card holders based on the one or more predictive political affiliation and/or attitude profiles.

The present disclosure also provides a system that includes providing targeted information, based on the one or more predictive political affiliation and/or attitude profiles, to a payment card holder.

### BRIEF DESCRIPTION OF THE DRAWINGS

FIG. 1 is a diagram of a four party payment card system.

FIG. 2 shows illustrative information types used in the systems and the methods of the present disclosure.

FIG. 3 illustrates an exemplary dataset for the storing, reviewing, and/or analyzing of information used in the systems and the methods of the present disclosure.

FIG. 4 is a flow chart illustrating a method of determining political affiliations and/or attitudes of payment card holders, in accordance with exemplary embodiments of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, or coaxial cable, fiber optic cable, twisted pair, DSL, or wireless technologies such as infrared, radio, and microwave, are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information, and retrieve from one or more databases a second set of information comprising external information. The external information comprises merchant political affiliation and/or attitude information and payment card holder political affiliation and/or attitude information. The first set of information and the second set of information are analyzed to identify one or more associations between the payment card transaction information and the external information. Political affiliations and/or attitudes of payment card holders are determined based on the one or more associations.

Among many potential uses, the systems and methods described herein can be used to: (1) allow merchants to better target customers and/or enhance existing customer relationships; and (2) research purposes. Other uses are possible.

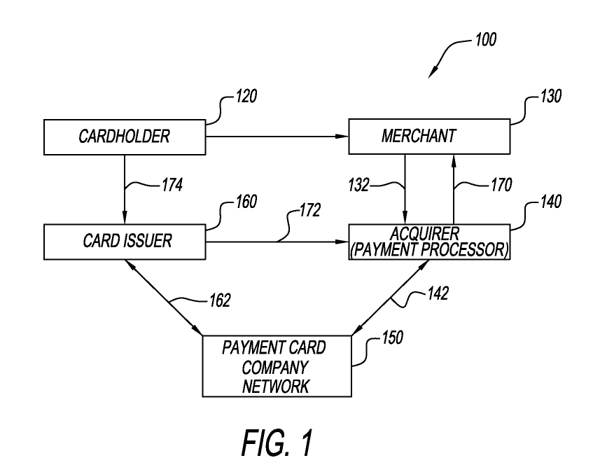

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

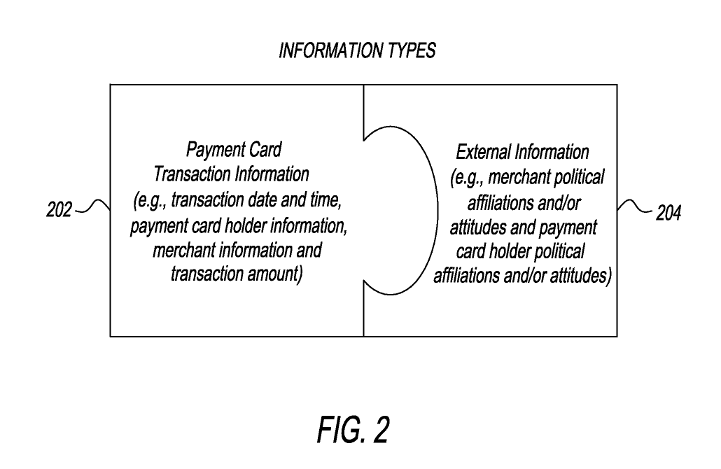

In accordance with the method of this disclosure, information that is stored in one or more databases can be retrieved (e.g., by a processor). FIG. 2 shows illustrative information types used in the systems and methods of this disclosure.

The information can contain, for example, a first set of information including payment card transaction information. Illustrative first set of information can include, for example, transaction date and time, payment card holder information, merchant information and transaction amount. In particular, the payment card transaction information can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information. Information for inclusion in the first set of information can be obtained, for example, from payment card companies known as MasterCard®, Visa®, American Express®, and the like (part of the payment card company network 150 in FIG. 1).

Also, the information can contain, for example, a second set of information including external information. Illustrative second set information can include, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments). The second set of information can be categorized, for example, by party affiliation, by geography or demographic segments, and the like. The second set of information can be clustered by category, for example, by political party, political activities, events, or other categories.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific predictive political affiliation and/or attitude profile is retrieved from each of the databases.

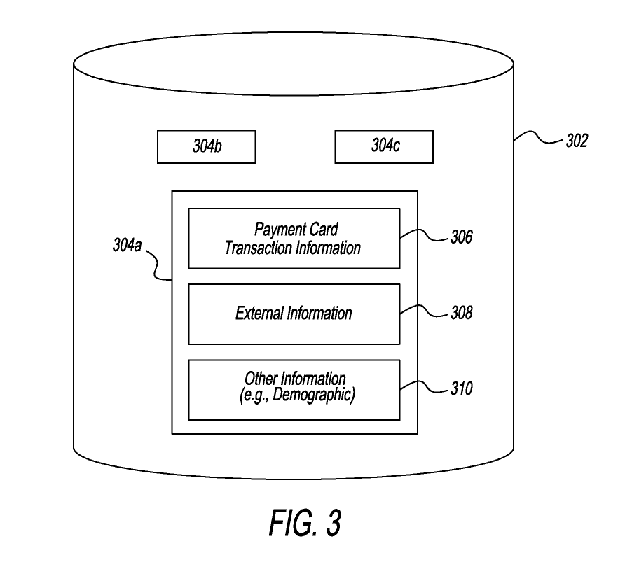

FIG. 3 illustrates an exemplary dataset 302 for the storing, reviewing, and/or analyzing of information used in the systems and methods of this disclosure. The dataset 302 can contain a plurality of entries (e.g., entries 304a, 304b, and 304c).

The payment card holder transaction information 306 includes payment card transactions and actual spending. The payment card transaction information 306 can contain, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), payment transaction amount information, and the like. The external information 308 includes, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments). Other information 310 can include demographic or other suitable information that can be useful in conducting the systems and methods of this disclosure.

Algorithms can be employed to determine formulaic descriptions of the integration of the payment card transaction information and the external information using any of a variety of known mathematical techniques. These formulas, in turn, can be used to derive or generate one or more analyses and updates for a political affiliation and/or attitude grouping or clustering activity using any of a variety of available trend analysis algorithms. For example, these formulas can be used to analyze the payment card transaction data and the external information to identify one or more associations between the payment card transaction information and the external information, and to determine political affiliation and/or attitude of payment card holders based on the one or more associations.

In an embodiment, logic is developed for predicting political affiliations and/or attitudes. The logic is applied to a universe of payment card transaction information and external information to determine political affiliations and/or attitudes of payment card holders.

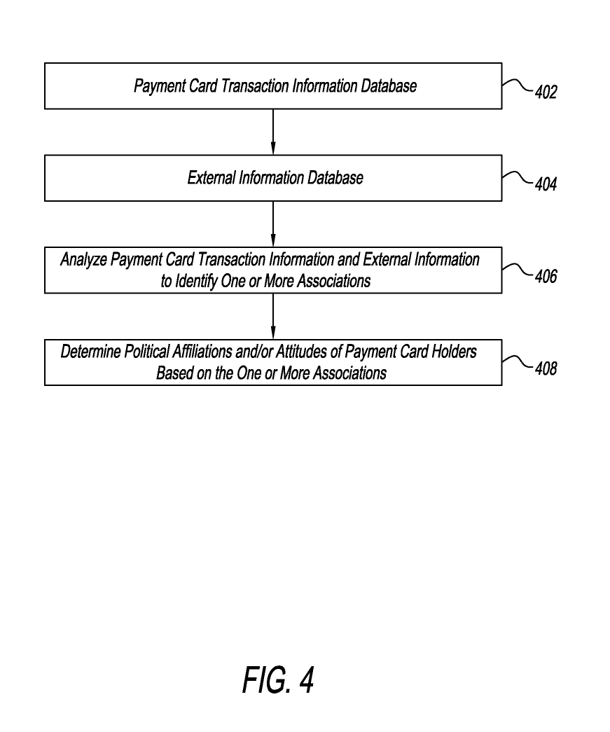

Referring to FIG. 4, the methods and the systems of this disclosure include retrieving at 402 from one or more databases a first set of information comprising payment card transaction information, and retrieving at 404 from one or more databases a second set of information comprising external information. The external information includes merchant political affiliation and/or attitude information and payment card holder political affiliation and/or attitude information. The method also includes analyzing at 406 the first set of information and the second set of information to identify one or more associations between the payment card transaction information and the external information. The method further includes determining at 408 the political affiliations and/or attitudes of payment card holders based on the one or more associations.

In particular, the methods and the systems of this disclosure include a segment for data analysis and a segment for applying insights. In the data analysis segment, a data layout universe is constructed including, but not limited to, payment card transaction data and external data. The payment card transaction data can include, for example, transaction date/time, payment card holder information (e.g., payment card holder account identifier (likely anonymized), payment card holder geography (potentially modeled), payment card holder type (consumer/business), payment card holder demographics, and the like), merchant information (e.g., merchant name, merchant geography, merchant line of business, and the like), and payment transaction amount information.

The external data can include, for example, merchant political affiliations and/or attitudes (e.g., political membership organizations, campaign donations, politically leaning charitable organizations), and payment card holder political affiliations and/or attitudes (e.g., list of payment card holders and their political affiliations, survey data, voter registration, and the like, and aggregate affiliation data such as party affiliation by geography or demographic segments).

Filters can be used for selecting certain data within the data layout universe. For example, a time range filter can be used that can vary based on need or data availability.

The data within the data layout universe is then analyzed to determine relationships between payment card transaction behavior and the external information (e.g., merchant political affiliation and/or attitude information and payment card holder political affiliation and/or attitude information). The analysis involves, for example, using standard statistical analysis techniques (e.g., clustering, regression, correlation, segmentation, raking, and the like). Logic and/or algorithms can be used in the analysis.

The data within the data layout universe is also analyzed to identify historic trends. For example, this analysis identifies which types of merchants correlate with specific political affiliations and/or attitudes, what patterns of spending are indicative of political affiliations and/or attitudes, and what patterns of spending are indicative of political interest versus ambivalence. The analysis involves, for example, using standard statistical analysis techniques (e.g., clustering, regression, correlation, segmentation, raking, and the like). Logic and/or algorithms can be used in the analysis.

In accordance with this disclosure, logic is developed for predicting political affiliations and/or attitudes, and quantification of the political affiliations and/or attitudes. The logic is applied to a universe of payment card transaction information and external information to determine political affiliations and/or attitudes of payment card holders. Algorithms can be employed to determine formulaic descriptions of the integration of the payment card transaction information and the external information using any of a variety of known mathematical techniques. For example, these formulas can be used to analyze the payment card transaction data and the external information to identify one or more associations between the payment card transaction information and the external information, and to determine political affiliation and/or attitude of payment card holders based on the one or more associations.

The logic can be used to create a process for utilizing historic payment card transaction data and historic external data for predicting current and future political affiliations and/or attitudes, and quantification of the political affiliations and/or attitudes. The process can be composed of logic or algorithm, supporting aggregate data based on payment transaction data, supporting data from external sources, and the like. The logic can be used to predict current and future political affiliations and/or attitudes of payment card holders.

In the applying insights segment, the method of this disclosure can be applied to a universe of payment card transaction information and external information to determine political affiliations and/or attitudes of payment card holders. The strength of the association between a payment card holder and political affiliations and/or attitudes can be quantified. The output from the applying insights segment can include, for example, payment card holder identification, a date/time transaction range, quantification of political engagement of the payment card holder (e.g., how engaged is the payment card holder in politics), political affiliations and/or attitudes of a payment card holder, and quantification of the confidence of the relationship between the one or more payment card holders and political affiliation and/or attitude (e.g., 80% confidence), and the like.

For example, payment card transaction data shows that a payment card holder donates money to several Republican candidates. Based on these associations, this payment card holder is determined to be politically engaged and is determined to be aligned with the Republican Party.

In another example, payment card transaction data shows that a payment card holder donates to the campaigns of several candidates of mixed political parties. Based on these associations, this payment card holder is determined to be politically engaged but does not have a strong affiliation with a single political party.

In yet another example, payment card transaction data shows that a payment card holder donates to politically active organizations (e.g., League of Women Voters) but has made no payment card transactions that suggest any political party affiliation. Based on these associations, this payment card holder is determined to be politically engaged but a political affiliation cannot be determined.

In a further example, a payment card holder is a member of several environmental organizations, donates to national public radio (e.g., NPR), and eats out regularly at a vegan restaurant. While there are no purchases to directly indicate political affiliation, it is likely that the individual is aligned with political attitudes of Democrats versus Republicans. The degree of political engagement is unknown.

One or more predictive political affiliation and/or attitude profiles can be generated based on the associations between the payment card transaction information and the external information. The predictive political affiliation and/or attitude profiles are discussed more fully hereinbelow.

The above examples illustrate how the systems and the methods of this disclosure can be used to make associations between payment card holder transaction information and external information. In particular, the systems and the methods of this disclosure can be used by merchants or businesses to better target customers or to enhance existing customer relationships.

As indicated herein, the systems and the methods of this disclosure utilize standard statistical techniques (e.g., clustering, regression, correlation, segmentation, raking, and the like) to identify one or more associations between the payment card transaction information and the external information. The associations or relationships can be refined by looking at factors such as time, frequency, and the like.

Logic can be created for associating the payment card transaction information and the external information and then quantifying their relationship (e.g., confidence quantifier). Once the logic has been created, it can be applied to the universe of payment card transaction information and external information to determine political affiliations and/or attitudes of one or more payment card holders. Attributes (e.g., confidence, time, frequency, and the like) can then be assigned to the payment card holders to make the data useful to potential end users such as marketers.

In accordance with the methods of this disclosure, one or more predictive political affiliation and/or attitude profiles are generated based on associations identified between the payment card transaction information and the external information. Predictive political affiliation and/or attitude profiles can be selected based on the information obtained and stored in the one or more databases. The selection of information for representation in the predictive political affiliation and/or attitude profiles can be different in every instance. In one embodiment, all information stored in each database can be used for selecting predictive political affiliation and/or attitude profiles. In an alternative embodiment, only a portion of the information is used. The generation and selection of predictive political affiliation and/or attitude profiles can be based on specific criteria.

A method for generating one or more predictive political affiliation and/or attitude profiles is an embodiment of this disclosure. The method includes retrieving from one or more databases a first set of information comprising payment card transaction information, and retrieving from one or more databases a second set of information comprising external information. The external information has merchant political affiliation and/or attitude information and payment card holder political affiliation and/or attitude information. The method also includes analyzing the first set of information and the second set of information to identify one or more associations between the payment card transaction information and the external information, and generating one or more predictive political affiliation and/or attitude profiles based on the one or more associations.

A political affiliation and/or attitude confidence score can be used for conveying to the one or more entities the political affiliations and/or attitudes attributable to the one or more payment card holders based on the one or more predictive political affiliation and/or attitude profiles. The political affiliation and/or attitude confidence score is indicative of likelihood of a payment card holder to affiliate with a particular political party, support a particular political issue, and the like.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information;
retrieving from the one or more databases a second set of information comprising external information, wherein the external information comprises merchant political affiliation and/or attitude information and payment card holder political affiliation and/or attitude information;
analyzing the first set of information and the second set of information to identify one or more associations between the payment card transaction information and the external information; and
determining political affiliation and/or attitude of one or more payment card holders based on the one or more associations.

2. The method of claim 1, further comprising developing logic for predicting political affiliations and/or attitudes, and applying the logic to a universe of payment card transaction information and external information to determine political affiliations and/or attitudes of the one or more payment card holders.

3. The method of claim 1, further comprising quantifying the strength of the political affiliations and/or attitudes of the one or more payment card holders.

4. The method of claim 1, further comprising, with respect to the political affiliations and/or attitudes of the one or more payment card holders, assigning attributes to the one or more payment card holders, wherein the attributes are selected from the group consisting of one or more of confidence, frequency, and time.

5. The method of claim 4, further comprising identifying one or more payment card holders, identifying a date/time transaction range, quantifying political engagement of the payment card holder, identifying political affiliation and/or attitude of the payment card holder, and/or quantifying the strength of the relationship between the one or more payment card holders and political affiliation and/or attitude.

6. The method of claim 4, further comprising targeting information including at least one or more suggestions or recommendations for payment card holder spending or purchasing activity, based on the political affiliation and/or attitude of the one or more payment card holders.

7. The method of claim 1, wherein the payment card transaction information comprises transaction date and time, payment card holder information, merchant information and transaction amount.

8. The method of claim 1, wherein the merchant political affiliation and/or attitude information comprises political membership organization information, campaign donation information and politically leaning charitable organization information, and wherein the payment card holder political affiliation and/or attitude information comprises a list of payment card holders and their political affiliations, survey data and voter registration information.

9. The method of claim 1, wherein the political affiliation and/or attitude of the one or more payment card holders is determined by statistical analysis selected from the group consisting of clustering, regression, correlation, segmentation, and raking.

10. A system comprising:
one or more databases including a first set of information comprising payment card transaction information;
one or more databases including a second set of information comprising external information, wherein the external information comprises merchant political affiliation and/or attitude information and payment card holder political affiliation and/or attitude information; and
a processor configured to:
analyze the first set of information and the second set of information to identify one or more associations between the payment card transaction information and the external information; and
determine political affiliation and/or attitude of one or more payment card holders based on the one or more associations.

11. The system of claim 10, wherein the processor has a programmed logic to predict political affiliations and/or attitudes, and wherein the logic is applied to a universe of payment card transaction information and external information to determine political affiliations and/or attitudes of the one or more payment card holders.

12. The system of claim 10, wherein the processor quantifies the strength of the political affiliations and/or attitudes of the one or more payment card holders.

13. The system of claim 10, wherein the processor, with respect to the political affiliations and/or attitudes of the one or more payment card holders, assigns attributes to the one or more payment card holders, and wherein the attributes are selected from the group consisting of one or more of confidence, frequency, and time.

14. The system of claim 10, wherein the processor is configured to perform one or more of the functions selected from the group consisting of: identifies one or more payment card holders; identifies a date/time transaction range; quantifies political engagement of the payment card holder; identifies political affiliation and/or attitude of the payment card holder; quantifies strength of the relationship between the one or more payment card holders, and quantifies political affiliation and/or attitude of the payment card holder.

15. The system of claim 10, wherein the processor targets information including at least one or more suggestions or recommendations for payment card holder spending or purchasing activity, based on the political affiliation and/or attitude of the one or more payment card holders.

16. The system of claim 10, wherein the payment card transaction information comprises transaction date and time, payment card holder information, merchant information and transaction amount.

17. The system of claim 10, wherein the merchant political affiliation and/or attitude information comprises political membership organization information, campaign donation information and politically leaning charitable organization information, and wherein the payment card holder political affiliation and/or attitude information comprises a list of payment card holders and their political affiliations, survey data and voter registration information.

18. The system of claim 10, wherein the political affiliation and/or attitude of the one or more payment card holders is determined by statistical analysis selected from the group consisting of clustering, regression, correlation, segmentation, and raking.

19. A method for generating one or more predictive political affiliation or attitude profiles, said method comprising:
retrieving from one or more databases a first set of information comprising payment card transaction information;
retrieving from the one or more databases a second set of information comprising external information, wherein the external information comprises merchant political affiliation and attitude information and payment card holder political affiliation and attitude information;
analyzing the first set of information and the second set of information to identify one or more associations between the payment card transaction information and the external information; and
generating one or more predictive political affiliation or attitude profiles based on the one or more associations.

20. The method of claim 19, further comprising determining political affiliation or attitude of one or more payment card holders based on the one or more predictive political affiliation and/or attitude profiles.
